(19) United States
(12) Patent Application Publication
(10) Pub. No.: US 2026/0104830 A1
(43) Pub. Date: Apr. 16, 2026

(54) METHODS AND SYSTEMS FOR SECURING DOCUMENTS WHILE PRINTING AND REPRODUCING THE DOCUMENTS

(71) Applicant: Xerox Corporation, Norwalk, CT (US)

(72) Inventors: Packiya Lakshmi Balusamy, Chennai (IN); Ravindranath Mannuru, Kadapa (IN); Prathi Koteswara Rao, Guntur (IN)

(21) Appl. No.: 18/913,082

(22) Filed: Oct. 11, 2024

(51) Int. Cl. G06F 3/12; B41M 3/14

(52) U.S. Cl. CPC G06F 3/1238; B41M 3/144; G06F 3/1222

(57) ABSTRACT

The disclosure discloses methods and systems for securing confidential content of a document while printing and/or while reproducing the document. The method includes identifying confidential content in a document. Upon identification, the confidential content is encoded based on one or more encoding algorithms. Then, coordinate information about the confidential content is identified. The method generates a pre-defined code such as a QR code having authorized user information, prints the IR security mark and pre-defined code on the document. The printed document includes the confidential content in an encoded format, the IR security mark with the coordinate information of the confidential content and the pre-defined code including the authorized user information. At the time of reproducing, the method includes checking if a user who is requesting for reproducing the printed document is an authorized user. Based on the check, the user is allowed to reproduce the printed document.

### TECHNICAL FIELD

The present disclosure relates to the field of document security. More specifically, the disclosure relates to methods and systems for securing documents while printing and/or while reproducing the documents.

### BACKGROUND

These days the most common and popular approach of securing documents is through special marks such as infrared (IR) security marks. To read such special marks, special IR readers or a source of light is needed. The use of such dedicated devices may increase the overall cost, add dependency in the system and so on. For example, if an IR scanner is not functioning due to various reasons, then there is no way to detect/read IR security marks in the documents. Moreover, a dedicated person is needed who uses the IR scanner to detect such marks in the documents. When the documents having IR security marks are scanned or copied, current solutions block or stop the scan/copy activity when the IR security mark is detected. The document with IR security mark is restricted for further action such as copy or scan. This becomes a problem when some portion of the document represents confidential content instead of the whole document.

Some enhancement is seen in IR security mark feature. For example, the enhanced solutions hide or blank out confidential content without stopping/blocking the scan or copy activity. Such enhanced solutions allow the user to mark select confidential content with IR security mark. For example, confidential content in documents like SSN, PAN, Aadhar, Passport No etc. can be marked. While scanning or copying, the document is classified as confidential or not based on IR security mark detection process. If it is confidential document, then confidential contents regions are hidden/blanked out in the final scan or copy output. But the concern with these solutions is that they disclose the place where the confidential content is present in the document which might lead to revealing the secured/confidential content easily. This further leaves a loophole for any hacker to easily identify the confidential content location and retrieve it by some means. Further, the existing solutions do not have the feature of reproducing confidential documents for authorized users without blocking copy/scan operation. Additionally, IR security mark has space limitation. For example, the IR security mark can only store limited information such as confidential content coordinates. In this light, there is a need for improvised solutions for securing documents at the time of printing and/or at the time of reproducing the documents or other operations.

### SUMMARY

According to aspects illustrated herein, a method for securing confidential content of a document while printing is disclosed. The method includes receiving the document from the user. Then, confidential content in the document is identified. Upon identification, the confidential content of the document is encoded. Then, coordinate information of the confidential content is embedded in an infrared (IR) security mark. Thereafter, a pre-defined code is generated including authorized user details. Finally, the document is printed such that the printed document includes the confidential content, IR security mark with the coordinate information of the confidential content and the pre-defined code with the authorized user details.

According to further aspects, a method for reproducing a document is disclosed, wherein the document is a printed document including encoded confidential content, an infrared (IR) security mark including coordinate information about confidential content of the document and a pre-defined code including authorized user details. The method includes retrieving the authorized user details from the pre-defined code. Then, it is checked if the user requesting for reproducing the document is an authorized user. Based on the check, the coordinate information of the confidential content from the IR security mark is retrieved. The confidential content of the document is decoded. Finally, the document is reproduced such that the reproduced document includes the decoded confidential content, the IR security mark, and an updated pre-defined code.

According to additional aspects illustrated herein, a multi-function device for securing confidential content of a document while printing is disclosed. The multi-function device is for: receiving the document for printing; identifying confidential content in the document; upon identification, encoding the confidential content of the document; embedding coordinate information of the confidential content in an IR security mark; generating a pre-defined code including authorized user details; and printing the document such that the printed document includes the encoded confidential content, IR security mark with the coordinate information of the confidential content and the pre-defined code comprising the authorized users details.

According to furthermore aspects a multi-function device for reproducing a document is disclosed, wherein the document is a printed document including encoded confidential content, an infrared (IR) security mark including coordinate information about confidential content of the document and a pre-defined code including authorized user details. The multi-function device includes one or more modules for: retrieving the authorized user details from the pre-defined code; checking if a user requesting for reproducing the document is an authorized user; based on the check, retrieving the coordinate information of the confidential content from the IR security mark; decoding the confidential content of the document; and reproducing the document such that the reproduced document including the decoded confidential content, the IR security mark and an updated pre-defined code.

According to additional aspects illustrated herein, a method for securing confidential content of a document while printing and/or while reproducing the document is disclosed. The method includes receiving the document for printing from a user. Then, confidential content in the document is identified. Upon identification, the confidential content of the document is encoded. Then, coordinate information of the confidential content is embedded in an infrared (IR) security mark. A pre-defined code is generated including authorized user information. The document is printed such that the printed document includes the encoded confidential content, IR security mark with the coordinate information of the confidential document and the pre-defined code including the authorized user information. This way, the document is secured while printing. Later the same user or other user wishes to reproduce the document and the workflow is discussed. A request from a user for reproducing the secured printed document is received, wherein the printed document includes the encoded confidential content, the IR security mark and the pre-defined code. It is checked if the user requesting for reproducing the document is an authorized user. Then, based on the check, coordinate information of the confidential content from the IR security mark is retrieved. Based on the check, the confidential content of the document is decoded. The document is reproduced such that the reproduced document includes the decoded confidential content, the IR security mark and an updated pre-defined code.

Other and further aspects and features of the disclosure will be evident from reading the following detailed description of the embodiments, which are intended to illustrate, not limit, the present disclosure.

### BRIEF DESCRIPTION OF THE DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIGS. 1A and 1B show exemplary environments in which various embodiments of the present disclosure can be practiced.

FIG. 2 is a block diagram illustrating various components of a multi-function device, in accordance with an embodiment of the present disclosure.

FIGS. 3A-3B represent tables with exemplary input and output values.

FIGS. 4A-4C show exemplary snapshots for implementing the present disclosure.

FIGS. 5A-5C show examples of IR security marks while scanning the document.

FIG. 6 is a method flowchart for securing a document while printing a document.

FIG. 7 is a method flowchart for reproducing a secured printed document.

### DETAILED DESCRIPTION

A few inventive aspects of the disclosed embodiments are explained in detail below with reference to the various figures. Embodiments are described to illustrate the disclosed subject matter, not to limit its scope, which is defined by the claims. Those of ordinary skill in the art will recognize a number of equivalent variations of the various features provided in the description that follows.

### Non-Limiting Definitions

In various embodiments of the present disclosure, definitions of one or more terms that will be used in the document are provided below. For a person skilled in the art, it is understood that the definitions are provided just for the sake of clarity and are intended to include more examples in addition to the examples provided below.

The term “multi-function device” is a single device or a combination of multiple devices, to perform one or more functions such as, but not limited to, printing, imaging, copying, scanning, and so forth. The multi-function device may include software, hardware, firmware, or a combination thereof. In the context of the current disclosure, the multi-function device secures a document including confidential content while printing the document as well as reproducing the document.

The term “document” refers to any document having confidential content or otherwise confidential for individual users, organizations, nation, or the like. Various examples of such confidential documents may be, but are not limited to, cheques, legal documents, bank bonds, research data, contract documents, prescriptions, coupons, tickets, invoices, identity proof, address proof, or disclosure documents. These are few examples, but the document can be any document which is confidential to the user. The document submitted for printing is in the form of digital. The document submitted for reproducing is in the printed paper form.

The term “reproducing” refers to recreating the document either via scan operation or via copy operation. The output generated from scan operation is a digital version while output generated from copy operation is in physical form such as printed on paper form.

The term “security mark” refers to a mark added/printed/embedded in the document to ensure its authenticity/genuineness/originality/confidentiality. In the context of the disclosure, the security mark refers to an invisible security mark. The security mark can be in the form of text, or image. The security mark can be referred to as IR security mark, or IR mark. The IR security mark refers to any machine-readable code that is not apparent to human eyes, in fact, requires a dedicated scanner/device to read the IR security mark.

The term “a pre-defined code” refers to any machine-readable code that can be 2-dimensional code such as a QR code. The pre-defined code includes information such as authorized users' information. For example, the pre-defined code includes a link to a location such as a server where the authorized user details are stored. There can be other codes as known or later developed, without limiting the scope of the disclosure. The pre-defined code refers to any machine-readable code that is generally visible to human eyes. The disclosure is discussed with respect to QR code as an example but can be implemented for other machine-readable codes which are 1-dimensional codes such as bar code, etc. The term “pre-defined” means that the code follows a defined format, but does not necessarily mean that the code itself is already known.

The term “user” refers to any user who submits the document for printing. The user may be the owner of the document or maybe any user who has access to print the document. The term user may be referred to as an original user. The term “authorized users” refers to any users who can access the printed document and/or can further reproduce the printed document.

The term “authorized user information” refers to details associated with the authorized user who can access the printed document and/or reproduce the printed document. The details can be his employee ID, employee name, username, password, unique code, One Time Password (OTP), user ID, phone number and so. The authorized user information can also include access rights by the user who submitted the document for printing. The authorized user information can also include a job action such as scanning or copying, he is allowed to perform with the printed document and number of copies he can reproduce, for example, 1, 2 or more. These are examples but the authorized user information can include any relevant information associated with the authorized user for implementing the disclosure such as his credentials, actions he can perform, number of copies he can reproduce.

The term “requesting user” refers to the user who submits a request for reproducing the secured document/printed document.

The document after printing refers to a secured document and the secured document is considered for reproducing the document. Specifically, the confidential content is decoded while reproducing the document after proper authorization of the requesting user.

### Overview

To overcome the shortcoming of the known solutions and arts, the present disclosure provides improvised methods and systems for securing confidential content of documents while printing as well as at the time of re-producing the document either via copy or scan operation. For example, the methods and systems encode confidential content while printing instead of hiding/blanking out the confidential such that no user can easily identify which portion of the document represents the confidential content. Similarly, the methods and systems validate the user who is performing scan or copy operation before decoding the confidential content for the user. The disclosure proposes a multi-level approach to secure confidential content of the document. For example, the disclosure implements encoding of the confidential content, embedding a pre-defined code such as QR code to store authorized user information and embedding an IR security mark to store coordinate information of the confidential content. The system prints the document such that the printed document includes the confidential content in an encoded format, the IR security mark with coordinate information of the confidential content and the QR code with authorized user information. This way, the methods and systems secure the document while printing such that the confidential content cannot be accessed in the printed document. At the time of reproducing the secured printed document, the system retrieves authorized user information from the QR code, matches the retrieved information with credentials of the requesting user. Based on the matching, the encoded confidential content is decoded and finally the document is reproduced.

### Example Environment

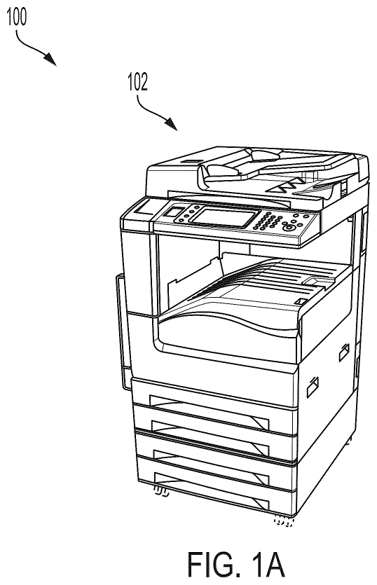

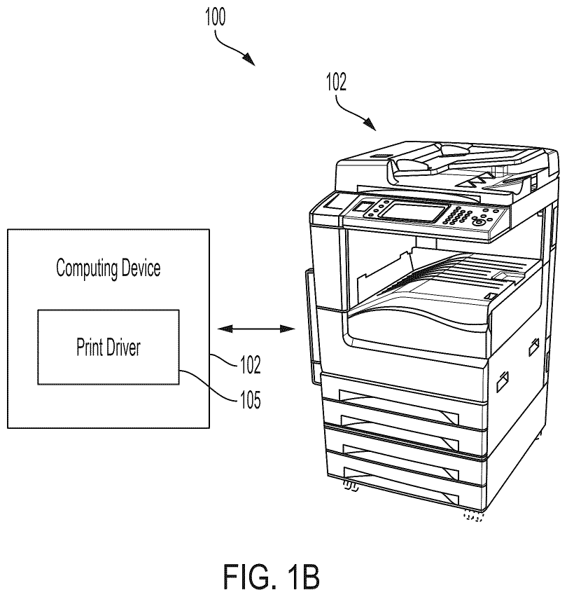

FIG. 1A illustrates an example environment 100 in which various embodiments of the disclosure can be practiced. The environment 100 includes a multi-function device 102 that performs one or more functionalities such as scanning, copying, printing, imaging, or other functionalities. In context of the current disclosure, the multi-function device 102 secures confidential content of a document while printing the document and ensures secure access while reproducing the same document via scan or copy operation.

In operation, a user submits a document for printing and the user wishes to secure confidential content of the document. The document can be any document such as identity proof, address proof, bank statement, passport, voter card, official document, personal document, medical prescription, report, or the like. The document can be in any known or later developed format and can have content in the form of image, text, graphics, or a combination thereof. The document may have one page or may have multiple pages and further may or may not have page numbers without limiting the scope of the disclosure. The user submits the document for printing via a print driver (see FIG. 1B), via a memory of the multi-function device 102, via a cloud location accessible at the multi-function device 102, via portable storage device that can be connected to the multi-function device 102 or the like.

While submitting the document for printing, the user selects the confidential content in the document. The user can select the confidential content via the print driver option or directly at the multi-function device 102. For example, a number of selection options can be provided in the print driver interface that allows the user to select the confidential content. Here, the user manually selects the confidential content via the one or more options provided in the print driver. Alternatively, Natural Language Processing (NLP) based approach may be used to identify/locate the confidential content like SSN, PAN, Aadhar, Passport No etc. in the document. Various examples of NLP based algorithms may include but are not limited to NER, POSTag analysis, etc. Any known or later developed approach may be used to identify confidential content of/in the document.

Upon identification of the confidential content, the multi-function device 102 then encodes the confidential content, generates a pre-defined code such as a QR code, includes authorized user information in the QR code, generates an IR security mark, embeds coordinate information of the confidential content in the IR security mark and finally prints the document with IR security mark and the QR code. The document is printed such that the printed document includes the encoded confidential content, IR security mark with the coordinate information of the confidential content and the QR code with one or more authorized users' information. For example, if the confidential content is passport number “AA 012345678”, then the multi-function device 102 encrypts the confidential content to “!! ZPMGKQVAI”. This way, any user including hackers cannot easily identify the confidential content. In some implementations, the multi-function device 102 encodes the confidential content and retains the original font and color of the confidential content. In other implementations, the multi-function device 102 encodes the confidential content as well as encodes the font and color of the confidential content.

The user can collect the printed document and/or may handover the printed document to another user for further processing, for example, a bank official. Another user may need to recreate the printed document for records or verification purposes. The bank official here may use the same multi-function device 102 or equivalent multi-function device with all functionalities for recreating the secured printed document. It can be considered that the bank official user logs in into the same multi-function device 102 and submits the document for scanning/copying. At the time of scan/copy operation, the multi-function device 102 detects the IR security mark and classifies the document as confidential based on the IR security mark detection process. The multi-function device 102 reads and retrieves the authorized user information from the QR code and validates against the login user details (bank official details in this case). The multi-function device 102 authorizes the bank official user and then decode/decrypts the confidential content in the document based on the coordinate information retrieved from the IR security mark and finally performs copy/scan. Here, the multi-function device 102 authorizes the user such as bank official before decoding the confidential content and outputs the scanned/copied version. This way, the multi-function device 102 provides an advanced level of security to secure the confidential content while recreating the printed document.

In example of FIG. 1A, the user directly selects and submits the document for printing at the multi-function device 102 as discussed above. But the user can submit the document for printing from a computing device or a print driver application running on the computing device. This example scenario/environment 110 is discussed in FIG. 1B. As shown, the multi-function device 102 is communicatively coupled to the computing device 104. The computing device 104 includes a print driver application 105 that allows the user to submit the document for printing. The print driver 105 further allows the user to provide one or more print properties for printing the document. In context of the current disclosure, the print driver 105 allows the user to indicate that the document includes confidential content. The print driver 105 further allows the user to select the confidential content in the document. For example, one or more selection boxes/areas are presented to the user via the print driver and the user can select the area that includes the confidential content. This way, the confidential content is selected or marked by the user. Alternatively, the print driver 105 can identify the confidential content in the document. The user can further indicate that he wishes to secure the confidential content. To this end, the print driver 105 may include an option in the form of a checkbox. The user can select that given checkbox option. Further, the print driver 105 requests the user to input authorized user information, the authorized user information includes details of the users with whom the printed document can be shared or the users who can later reproduce the printed document. The authorized user information can be username, password, passcode, login credentials, email address, phone number, employee ID or the like. The print driver 105 then finally sends the document, print properties, selection of the secure option, the selected confidential content, the authorized user information, details of the user, etc. to the multi-function device 102 further processing. The multi-function device 102 processes the received information and outputs the printed documents such that the printed document includes the confidential content in the encoded format with the QR code and the IR security mark. The QR code includes the authorized user information, and the IR security mark includes coordinate information about the confidential content. More details will be discussed in detail below.

### Example System

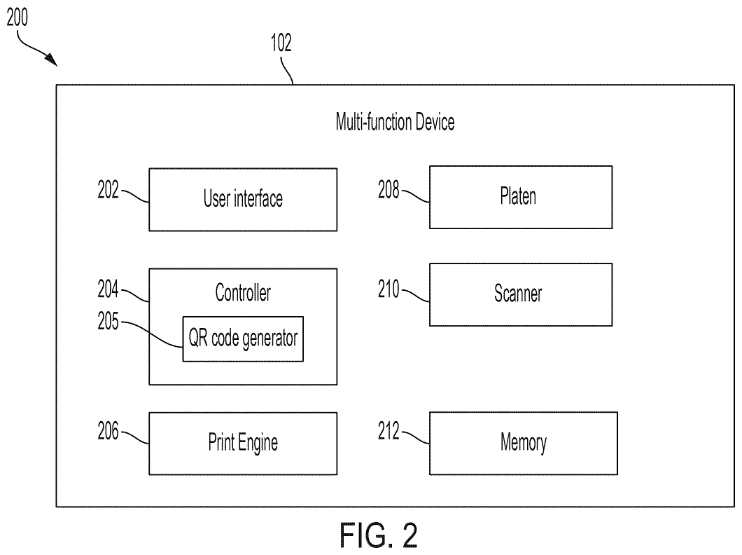

FIG. 2 illustrates an example system 200 for securing confidential content of a document while printing as well as for providing secure access while reproducing the document. The system 200 includes a multi-function device 102 including a user interface 202, a controller 204 including a QR code generator 205, and an IR security mark generator 207, a print engine 206, a platen 208, a scanner 210, and a memory 212. Some system components 202-212 may be used for securing confidential content while printing such as the user interface 202, the controller 204, the print engine 206, and the memory 212. Some system components may be used for reproducing the document such as the platen 208, the scanner 210 and the memory 212. Each of the components 202-212 is connected to each other via a conventional bus or a later developed protocol. Further, the components 202-212 communicate with each other for implementing the current disclosure. The multi-function device 102 may be communicatively coupled to other devices such as computing device or print driver of the computing device.

The implementation begins when a user wishes to secure a document while printing. The user submits the document for printing. The document can be any document including content in the form of text, image, graphics, or a combination thereof. The document includes confidential content or content that the user wishes to secure. The document can be in any format such as MS word, PDF, JPEG, or the like. These are few examples, the document can be in other formats as known or later developed formats. The user uses a computing device such as 104 (although not shown in FIG. 2, see FIG. 1B) for submitting the document for printing. The computing device 104 includes a print driver 105 that allows the user to submit the document for printing. Along with the document, the user submits one or more print parameters for printing such as color, orientation, number of copies, number of pages, finishing options or the like. In context of the current disclosure, the user marks the confidential content. The user can mark the confidential content via the print driver 105. In such cases, the print driver 105 provides options that allow the user to mark the confidential content. Alternatively, the user can input the confidential content manually. In some implementations, the print driver 105 can identify the confidential content of the document using one or more known algorithms or later developed algorithms. This way, the confidential content of the document is identified. The user thereafter inputs one or more other users' information who are authorized to access the printed document and are authorized to further reproduce the printed document. The other users as input by the user refer to the authorized users. For example, the user can provide their user details such as username, employee ID, employee name, department ID, email address, phone number or the like. The print driver 105 then sends the document, print parameters, the confidential content, the authorized user information or other relevant information to the multi-function device 102 for further processing.

The multi-function device 102 receives the document, the print parameters, the confidential content, the authorized user information or other relevant information. Specifically, the controller 204 receives the details sent from the print driver 105 or the computing device 104.

In some implementations, the user can directly submit the document for printing at the multi-function device 102. For example, the document may be stored in the memory 212 of the multi-function device 102. The user can select the document for printing directly from the memory 212 of the multi-function device 102. Further, the user can further select the confidential content directly at the multi-function device 102. For example, one or more selection options may be included in the user interface 202 for selecting the confidential content. The user can further provide authorized user information via the user interface 202 of the multi-function device 102. For example, the user interface 202 may provide a text box where the user can input authorized user information. The authorized user information may include the number of users he wishes to give access to and their corresponding details such as their names, email addresses, phone numbers, designation, department, or the like. The authorized user information may further include a job action that can be performed by the other users as well as the number of copies he or she can reproduce. These are examples, but the authorized user information can have other details required for implementing the current disclosure.

The controller 204 triggers the QR code generator 205 for generating a QR code for the user and/or for the document. The QR code can be generated as per the known methods or later developed methods. While generating the QR code, the QR code generator 205 includes authorized user information within the QR code for later retrieval, use and/or validation. The QR code can also include information of the user who sends the document for printing. The QR code generator 205 embeds the authorized user information in the QR code such that the details can be retrieved at later stages.

The controller 204 then detects the confidential content in the document and further identifies the location of the confidential content. Based on the location of the confidential content, the controller 204 then identifies coordinate information of the confidential content such as x coordinate, y coordinate, height, and width. The controller 204 then sends the coordinate information of the confidential content to the IR security mark generator 207. The IR security mark generator 207 generates an IR security mark indicating the document includes confidential content and further embeds the coordinate information of the confidential content in the IR security mark.

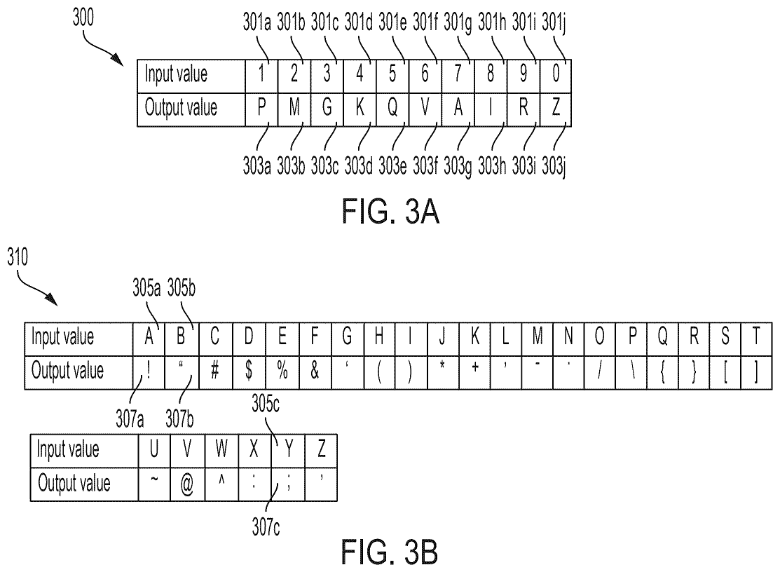

The controller 204 encodes the confidential content of the document. To this end, the controller 204 uses a pre-defined table such as look-up table for encoding the confidential content of the document. One such exemplary pre-defined table 300 is shown in FIG. 3A. The table 300 includes input values which represent original characters from 1-0 and from A-Z and output values which represent a character to be replaced within the confidential content. As shown, the input value “1” (marked as 301a) has a corresponding output value “P” (marked as 303a), the input value “2”, (marked as 301b) has a corresponding output value “M” (marked as 303b), the input value “3” (marked as 301c), has a corresponding output value “G” (marked as 303c), the input value “4” (marked as 301d) has a corresponding output value “K” (marked as 303d), the input value “5” (marked as 301e) has a corresponding output value “Q” (marked as 303e), the input value “6” (marked as 301f) has a corresponding output value “V” (marked as 303f), the input value “7” (marked as 301g) has a corresponding output value “A” (marked as 303g), the input value “8” (marked as 301h) has a corresponding output value “I” (marked as 303h), the input value “9” (marked as 301i), has a corresponding output value “R” (marked as 303i), the input value “0” (marked as 301j) has a corresponding output value “Z” (marked as 303j).

Similarly, the output value is defined for each alphabet i.e., from A-Z as shown in table 310 of FIG. 3B. For example, the input value “A” (marked as 305a) has a corresponding value “!” 307a, the input value “B” (marked as 305b) has a corresponding output value “”” (marked as 307b) and the input value “Y” 305c has a corresponding output value “;” (marked as 307c). The input value represents a character in the confidential content and the output value represents a replacing character. For example, if the confidential content is PAN number BHFPS1569Q, the controller 204 replaces each character of the PAN number using the look up tables 300 and 310 of FIGS. 3A-3B. For example, B is replaced with ““”, H is replaced with “(“, F is replaced “&”, P is replaced with “\”, S is replaced with “[”, 1 is replaced with “P”, 5 is replaced with “Q”, 6 is replaced with “V”, 9 is replaced with “R” and “Q” is replaced with “{”. The encoded confidential content according to the present disclosure is “(&\[P Q V R{”.

The controller 204 encodes the confidential content in raster format of the confidential content i.e., replaces character of the confidential content based on the pre-defined tables stored in the memory 212 of the multi-function device 102. This way, the controller 204 protects the confidential content.

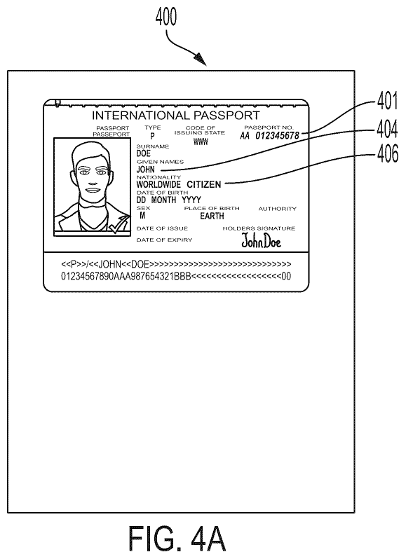

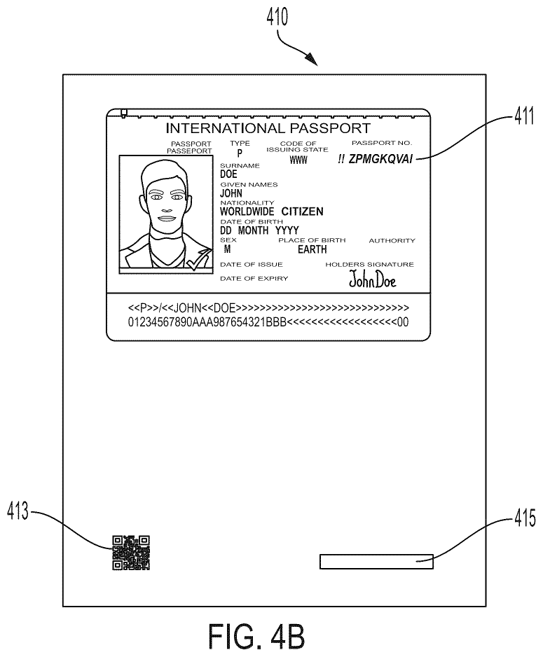

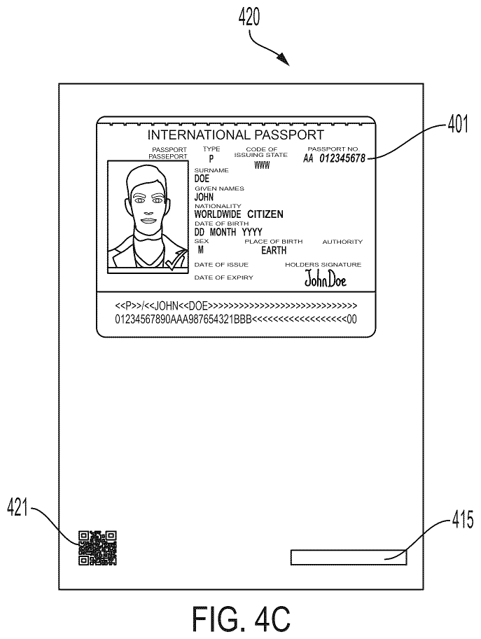

The controller 204 sends the QR code including the authorized user, IR security mark including the coordinate information of the confidential content and the encoded confidential content to the print engine 206. The print engine 206 finally prints the document such that the printed document includes the IR security mark, the QR code and the encoded confidential content while remaining content is printed as-is. One such exemplary printed document 410 according to the present disclosure is shown in FIG. 4B. This way, the confidential content is secured by encoding while printing such that no user can access or can know the location of the confidential content of the document. The user can share the printed document with any user, for example, a bank official. The user can share the printed document with any of his colleague.

The memory 212 stores relevant information required for implementing the current disclosure. For example, the memory 212 stores the pre-defined tables 300, 310 including input and output values. The memory 212 may store multiple tables such pre-defined tables for encoding the confidential content of the document. The memory 212 can further store user details, operations performed by the user and other details. Along with this, the memory 212 may store information such as access rights. These are a few examples but the memory 212 may store other relevant information required for implementing the present disclosure.

The user interface 202 allows the user to provide input and further displays one or more messages to the user. For example, the user interface 202 allows the user to select, mark or input confidential content, input authorized user information. In another example, the user interface 202 displays messages to the user such as “please collect your printed document”. Another message may be—“please confirm if the identified confidential content is correct.” The user interface 202 as shown is a part of the multi-function device 102, but the user interface 202 can be external to the multi-function device 102. For example, the user interface 202 can be a separate device which is communicatively coupled to the multi-function device 102.

The printed document can be handed over to another user such as bank official by the user. The other user can then use the document and perform all the needed tasks. Due to various reasons such as validation, record purpose, etc., the other user requires to reproduce the printed document either via scan or copy operation. The other user hereinafter will be referred to as the user.

The bank official user first logs in into a multi-function device for scanning or copying operation. The user can login based on username, password, employee ID, employee code, or the like. The multi-function device can be the same multi-function device 102 or can be a different multi-function but with the same capabilities as of 102 to secure the confidential content while printing and/or while reproducing the printed document. For easy discussion, it is considered that the bank official user logs in into the same multi-function device such as 102. In operation, the bank official user submits the printed document having the IR security mark, the QR code and the encoded confidential content. The controller 204 receives the printed document. Specifically, the user places the printed document on the platen 208. After placing this, the bank official user initiates scanning either pressing a scan button given on the multi-function device 102 or otherwise via scan option provided on the user interface 202 of the multi-function device 102. The controller 204 triggers the scanner 210 to scan the document and creates scanned data. The controller 204 performs all checks and retrieves information from the scanned data in an example. The controller 204 detects if the submitted document has any IR security mark. The controller 204 detects IR security mark based on one or more known or later developed methods. For example, the controller 204 can detect the IR security mark based on halftone frequency information, the halftone frequency information may be unknown to the multi-function device 102 and/or to the controller 204 and can be further estimated using various methods/techniques. In another example, the controller 204 can identify the IR security mark in the document based on known halftone frequency and known color information.

Based on the check, the controller 204 proceeds forward. For example, if the controller 204 identifies that the printed document has IR security mark, the controller 204 further checks if the QR code is present. If present, the controller 204 then reads the QR code to check if any user information is present in the QR code. The QR code includes the authorized user information. If found, the controller 204 then retrieves the authorized user information from the QR code. The controller 204 then matches the retrieved authorized user information with the information of the bank official user. For example, the controller 204 checks the authorized user information with the bank official user information such as login credentials, username, password or other credentials. The login credentials may be the credentials that the bank official user has used to login into the multi-function device 102. Based on matching, the controller 204 may perform an additional check. The controller 204 generates a code such as OTP, etc. and sends the generated code to the original user. The original user can be the owner of the document or can be the user who can provide access/authorize users for reproducing the secured document. The original user then shares the generated code with the bank official user who wants to reproduce the document. The generated code can be provided to the bank official user either via email, phone, message or the like. The controller 204 matches the code input by bank official user with the generated code.

If matches, the controller 204 proceeds forward, for example, the controller 204 then checks for information embedded in the IR security mark. If found, the controller 204 retrieves the coordinate information of the confidential content from the IR security mark. The controller 204 finally identifies the location of the confidential content. The controller 204 then decodes the confidential content based on the pre-defined tables stored in the memory 212. In the scanned data, the controller 204 replaces characters of the confidential content with corresponding input value based on the pre-defined tables. Once that is done, the controller 204 then applies one or more image processing algorithms etc. to create a scanned file. The controller 204 then triggers the QR code generator 205 to update or generate a new QR code, referred to as an updated QR code. The QR code generator 205 embeds additional information such as details of the bank official user who scanned the document along with the operation performed by the bank official user and number of copies created by the bank official user. This way, the updated QR code is generated. The updated/new QR code includes the authorized information as provided at the time of printing along with the additional information. The new QR code is included in the reproduced document such as scanned output. This way, the scanned output is created such that the scanned output includes the decoded confidential content and the new QR code.

The above example is discussed where the reproduced document is scanned document i.e., digital version. But in other examples, the reproduced document can be a copied document i.e., a document in the physical form.

In some implementations, the multi-function device 102 automatically identifies or detects confidential content in the document. The multi-function device 102 implements machine learning algorithms, based on training set, the algorithms are trained to detect the confidential content in the document. For example, the multi-function device 102 is provided with multiple documents, images, and content to enhance its detection capabilities.

### Example Snapshots

FIG. 4A shows an exemplary document such as passport 400 submitted for printing. The document passport 400 includes passport number such as 401 and other content such as name 404, nationality 406, and so on. Here, the passport number, marked as 401, is a confidential document. FIG. 4B shows an output after printing the document 400, i.e., a printed document 410 according to the present disclosure. The printed document 410 includes confidential content in an encoded format (marked as 411), a QR code 413 having authorized user information and IR security mark 415 having coordinate information about the confidential content. FIG. 4C shows an output 420 after reproducing the document, for example, via scanning the document. The output 420 includes the confidential content 401, the IR security mark 415 and an updated QR code 421. The updated QR code 421 includes job type performed by the authorized user and the number of times the scan/copy operation performed by the authorized user.

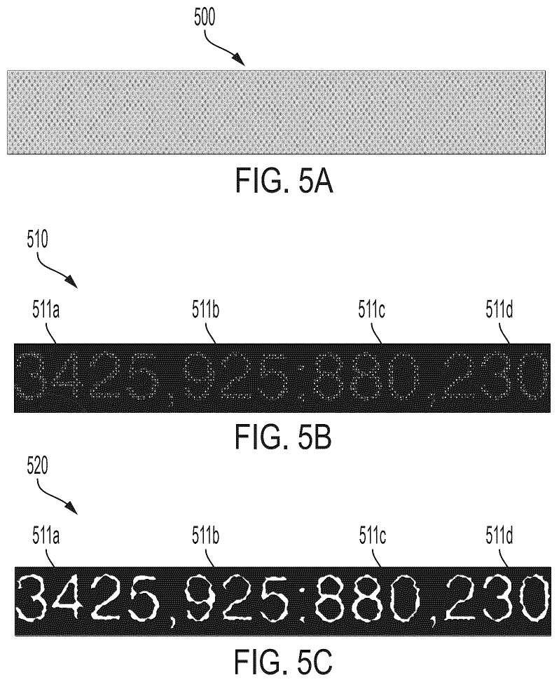

FIG. 5A shows an IR security mark 500 obtained while scanning the printed document, specifically, FIG. 5B shows an RGB image of a scanned IR security mark. After applying IR security mark detection techniques and segmentation techniques, an IR security mark image 510 including coordinate information is shown. The coordinate information includes x coordinate marked as 511a, y coordinate marked as 511b, height, marked as 511c and width, marked as 511d (collectively 511). Then, pixels shown in FIG. 5B are reconstructed using one or more morphological operations and the reconstructed pixels representing the coordinate information 511 is shown as 520 in FIG. 5C.

### Example Method Flowcharts

### Printing Scenario

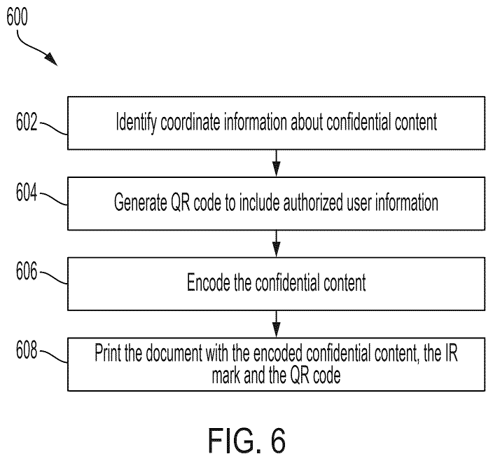

FIG. 6 is a method flowchart for securing confidential content while printing. The method 600 can be implemented at a multi-function device such as multi-function device 102.

The method 600 begins when a user submits a document for printing. The document can be any document that includes confidential content. For example, the document can be a passport where the confidential content can be passport number. The document for printing can be submitted via a print driver or via other options as discussed above in detail. While submitting the document for printing, the user selects the confidential content. One or more selection options are provided to the user for selecting the confidential content. In other examples, the user can input the confidential content which can be identified based on the user input. Alternatively, the confidential content can be automatically identified which can be confirmed with the user. In context of the current disclosure, the user provides authorized user information who can access the document or can recreate the document. The authorized user information can be username, user email address, user passcode, user phone number, user ID, or the like. The document along with the selection of the confidential content, the authorized user information is sent for further processing.

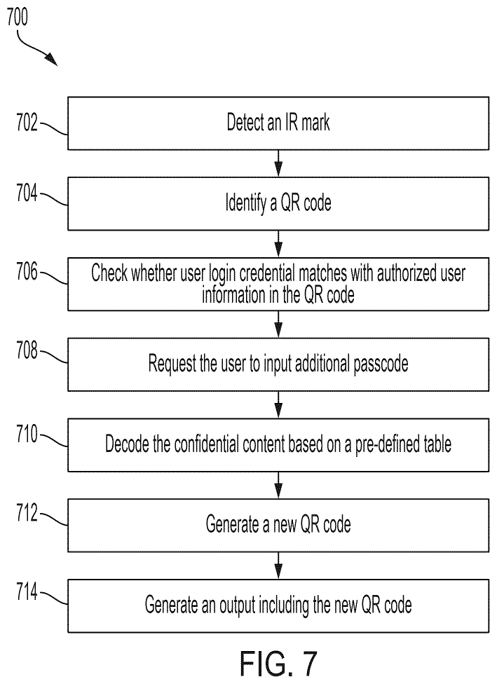

Based on the received information, the location of the confidential content is identified. Further, based on the location, coordinate information about the confidential content is identified at 602. The coordinate information can be x coordinate, y coordinate, width, and height. The coordinate information about the confidential content is stored in the IR security mark. At 604, a QR code is generated to include the authorized user information. The QR code includes information of all users and their details who can access the confidential content and/or can reproduce the document with the confidential content. The authorized user information is stored in the QR code for later retrieval. At 606, the confidential content is encoded. The confidential content can be encoded using the predefined tables as discussed above. But other variations may be implemented to encode the confidential content of the document. At 608, the document is printed such that the printed document includes the encoded confidential content, the QR code with the authorized user information, and IR security mark with coordinate information about the confidential content. Printing the document includes printing the IR security mark with the coordinate information about the confidential content and printing the QR code with the authorized user information. This way, the document is printed such that no confidential content is visible to other users. The user collects the printed document and submits to another person such as bank officials. Or the user prints the document for another person such as bank official and he can directly collect the printed document. The other user can reproduce the printed document for various purposes. The reproduction of the document including the confidential content is discussed in FIG. 7.

The method 600 is discussed where the document includes single confidential content but there can be scenarios where the document may have multiple confidential content. In such cases, the coordinate information of other confidential content can be stored in the QR code along with the authorized user information. This way, the method 600 solves the concerns associated with the IR security mark space.

### Reproducing Document Scenario

FIG. 7 is a method flowchart 700 for securing confidential content while reproducing the document, Specifically, the method 700 ensures secure access of the confidential content while reproducing the document. The method 700 can be implemented at same multi-function device as discussed above or the method 700 can be implemented at an equivalent multi-function device.

The method 700 begins when a user such as a bank official submits a document for reproducing the documents, for example, via scanning. The submitted document here represents a document in the physical form such as printed on paper. Before submitting, the bank official user logs in into the multi-function device. After login, the bank official user submits the document for scanning and scanned data is generated. The scanned data is considered for further processing and/or analysis. At 702, while scanning, an IR security mark is detected. Based on the detection of the IR security mark, it is identified whether the document, or some content in the document is confidential content. The IR security mark is read and the coordinate information about the confidential content is retrieved from the IR security mark. At 704, QR code is identified. Based on the identification, authorized user information is retrieved from the QR code. At 706, it is checked whether the bank official user login credential matches with the authorized user information stored in the QR code. Based on matching, the method 700 proceeds forward. This way, the login user is validated. Then at 708, the bank official user is requested to input an additional passcode. The user provides the passcode. The passcode can be the code provided to the user via phone by the original user. The passcode can be any passcode that further ensures the user reproducing the document is an authorized user. Then, at 710, encoded confidential content is decoded based on the pre-defined table or other tables stored in the memory. At 712, a new QR code is generated. The new QR code includes the user details who recreates the document along with any action performed by the bank official user. For example, the new QR code includes the operation/job type performed by the user, the number of times the user performs copy/scan, or the number of copies taken by the bank official user. This helps in tracking the operation performed by the authorized user such as bank official. The updated QR code gets added/embedded in the copied/scanned output. At 714, an output is generated such that the output includes the new QR code. The output can be a scanned output or copied output. The output can be stored by the bank official user for records purpose or can be used for verification purpose and so on.

The present disclosure secures confidential content of a document while printing and only allows authorized users to re-create the document including the confidential content, thereby providing advanced level of security for confidential content of the document.

The methods and systems propose a simple and easy approach such as look-up table-based approach for encoding the confidential content.

The disclosure automates existing methods in print/copy/scan path for IR security mark printing and detection. The methods and systems further help classify the confidential and non-confidential content.

The method proposes an enhanced IR security mark, where the enhancement is to encode the confidential content while printing the document instead of blanking out the confidential content.

The present disclosure encodes confidential content and puts the confidential content in an encoded format in the print. By implementing the encoding technique in the print path, no user can know if the confidential content is modified. The disclosure provides additional security in the print path. The methods and systems only allow authorized users to reproduce the document.

The methods and systems solve the concerns associated with the IR security mark by incorporating an additional mark such as QR code for storing authorized information and IR security mark for storing coordinate information of the confidential content. The methods and systems allow the original user to keep track of his document and/or know modification made in the document as well as kind of operation performed by another user.

The disclosure is useful for organizations working with sensitive documents. This is a system level approach to prevent employees from intaking sensitive information by programmatically eliminating the machine from doing so.

The order in which the method is described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof. However, for ease of explanation, in the embodiments described below, the method may be considered to be implemented in the above-described system and/or the apparatus and/or any electronic device (not shown).

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

Note that throughout the following discussion, numerous references may be made regarding servers, services, engines, modules, interfaces, portals, platforms, or other systems formed from computing devices. It should be appreciated that the use of such terms is deemed to represent one or more computing devices having at least one processor configured to or programmed to execute software instructions stored on a computer readable tangible, non-transitory medium or also referred to as a processor-readable medium. For example, a server can include one or more computers operating as a web server, database server, or other type of computer server in a manner to fulfill described roles, responsibilities, or functions. Within the context of this document, the disclosed devices or systems are also deemed to comprise computing devices having a processor and a non-transitory memory storing instructions executable by the processor that cause the device to control, manage, or otherwise manipulate the features of the devices or systems.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as receiving, storing, retrieving, scanning, copying, securing, encoding, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various embodiments also relate to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of non-transitory media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in a transitory media, such as a transmittable carrier wave in which the control program is embodied as a data signal using transmission media, such as acoustic or light waves, such as those generated during radio wave and infrared data communications, and the like.

In this document, the terms “controller” and “processor” refer to a hardware component of an electronic device that is configured to execute programming instructions. The terms “controller” and “processor” may refer to either a single device or to multiple devices that together implement various steps of a process. Unless the context specifically states that a single device is required or that multiple processors are required, the terms “controller” and “processor” include both the singular and plural embodiments.

In this document, the terms “memory,” “memory device,” “computer-readable medium” and “data store” each refer to a non-transitory device on which computer-readable data, programming instructions or both are stored. Unless the context specifically states that a single device is required or that multiple devices are required, the terms “memory,” “memory device” “computer-readable medium” and “data store” include both the singular and plural embodiments, as well as portions of such devices such as memory sectors.

In this document, the term “multi-function device” (or “MFD”) refers to a machine comprising hardware and associated software configured to enable the device to print documents on substrates, as well as perform at least one other function such as copying, facsimile transmitting or receiving, image scanning, or performing other actions on document-based data.

The terminology used herein is for the purpose of describing particular embodiments only and is not intended to be limiting of the disclosure. It will be appreciated that several of the above disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for securing confidential content of a document while printing, the method comprising:
receiving the document for printing from a user;
identifying confidential content in the document;
upon identification, encoding the confidential content of the document;
embedding coordinate information of the confidential content in an infrared (IR) security mark;
generating a pre-defined code comprising authorized user information; and
printing the document such that the printed document comprises the encoded confidential content, the IR security mark comprising the coordinate information of the confidential content and the pre-defined code comprising the authorized user's information.

2. The method of claim 1, further comprising receiving the authorized user information.

3. The method of claim 1, further comprising identifying the coordinate information of the confidential content.

4. The method of claim 1, further comprising embedding the authorized user information in the pre-defined code.

5. The method of claim 1, further comprising printing the IR security mark on the document comprising the coordinate information of the confidential content.

6. The method of claim 1, further comprising printing the pre-defined code comprising the authorized user information.

7. The method of claim 1, wherein the confidential content is identified automatically or based on an input from the user.

8. The method of claim 1, further comprising storing the coordinate information of the confidential content in the IR security mark.

9. The method of claim 1, further comprising storing the authorized user information in the pre-defined code.

10. The method of claim 1, further comprising receiving a request for reproducing the printed document comprising the encoded confidential content, the IR security mark and the pre-defined code, wherein the IR security mark comprising the coordinate information of the confidential content and the pre-defined code comprising the authorized user information.

11. The method of claim 10, further comprising retrieving the authorized user information from the pre-defined code.

12. The method of claim 10, further comprising matching details of a logged-in user with the authorized user information.

13. The method of claim 12, further comprising retrieving the coordinate information of the confidential content from the IR security mark, based on the matching.

14. The method of claim 12, further comprising decoding the confidential content, based on the matching.

15. The method of claim 14, further comprising, in response to the matching being successful, generating a reproduced document such that the reproduced document comprises the decoded confidential content, the IR security mark and an updated pre-defined code.

16. The method of claim 12, further comprising, in response to the matching being unsuccessful, generating a reproduced document such that the reproduced document comprises the encoded confidential content, the IR security mark and an updated pre-defined code.

17. The method of claim 10, further comprising generating an updated pre-defined code comprising a job action performed by the user, a number of times the job action is performed by the use, along with the authorized user information.

18. A method for reproducing a document, the method comprising:
receiving a secured printed document comprising encoded confidential content, an infrared (IR) security mark comprising coordinate information about the confidential content of the document, and a pre-defined code comprising authorized user information,
retrieving the authorized user information from the pre-defined code,
using the authorized user information to check whether a user requesting reproduction of the document is an authorized user;
based on the check, retrieving the coordinate information of the confidential content from the IR security mark;
decoding the confidential content of the document; and
reproducing the document such that the reproduced document comprises the decoded confidential content, the IR security mark, and an updated pre-defined code.

19. The method of claim 18, further comprising generating an updated pre-defined code comprising at least:
a job action performed by the user; and
a number of times the job action is performed by the user, along with the authorized user information.

20. A multi-function device, comprising:
a controller;
a memory containing that includes programming instructions that are configured to cause the controller to, in response to receiving a document for printing from a user:
identify confidential content in the document,
upon identification, encode the confidential content of the document,
embed coordinate information of the confidential content in an infrared (IR) security mark,
generate a pre-defined code comprising authorized user information, and
cause the print engine to print the document on substrate such that the printed document comprises the encoded confidential content, the IR security mark comprising the coordinate information of the confidential content, and the pre-defined code comprising the authorized user's information.
